(19) United States
(12) Patent Application Publication
(10) Pub. No.: US 2006/0095479 A1
(43) Pub. Date: May 4, 2006

(54) Primary and recovery file system management

(75) Inventors: Itzhack Goldberg, Hadera (IL); Kenneth Nagin, D.N. Natzrat Ilit (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/978,955

(22) Filed: Nov. 1, 2004

(51) Int. Cl. G06F 17/30

(52) U.S. Cl. 707/202

(57) ABSTRACT

A computer system having primary and recovery file system management, the system including a computing device, an operating system, a primary file system, and a recovery file system, where each of said file systems is labeled, prior to bootstrapping by the operating system the label of the recovery file system identifies the recovery file system as a primary file system, and the operating system is operative to swap the labels of the primary and recovery file systems during bootstrapping, attempt to mount said either of the file systems whose label identifies the file system as the primary file system, and swap the labels of the primary and recovery file systems if the file system whose label identifies it as the primary file system was mounted successfully and if the successfully mounted file system is the primary file system.

### FIELD OF THE INVENTION

The present invention relates to computer operating systems in general, and in particular to disaster recovery therefor.

### BACKGROUND OF THE INVENTION

When an operating system malfunctions and will not respond to the applications running on its kernel it is common practice to restart (reboot) the system, whereupon the operating system's primary file system is mounted. In many operating systems, such as Linux, if the primary file system cannot be successfully mounted, a recovery file system may be mounted, and the system may be placed into a safe mode under which diagnostics of the primary file system may be performed and repairs effected, such as by a system administrator. However, the ability to switch to a recovery file system typically requires a user interface and user intervention, elements that are generally not available in embedded systems. A system and/or method for managing primary and recovery file systems that do not have such requirements would therefore be advantageous.

### SUMMARY OF THE INVENTION

The present invention discloses a system and method for managing primary and recovery file systems.

In one aspect of the present invention a computer system is provided having primary and recovery file system management, the system including a computing device, an operating system, a primary file system, and a recovery file system, where each of the file systems is labeled, prior to bootstrapping by the operating system the label of the recovery file system identifies the recovery file system as the primary file system, and the operating system is operative to swap the labels of the primary and recovery file systems during bootstrapping, attempt to mount the either of the file systems whose label identifies the file system as the primary file system, and swap the labels of the primary and recovery file systems if the file system whose label identifies it as the primary file system was mounted successfully and if the successfully mounted file system is the primary file system.

In another aspect of the present invention the operating system is operative to determine whether the mounted file system is either of the primary file system and the recovery file system.

In another aspect of the present invention the operating system is operative to determine whether the mounted file system is either of the primary file system and the recovery file system by checking for the presence of a file on the primary file system that is known not to exist on the recovery file system.

In another aspect of the present invention the operating system is operative to determine whether the mounted file system is either of the primary file system and the recovery file system when a third file system is mounted.

In another aspect of the present invention the third file system is the /temp file system under the Linux operating system.

In another aspect of the present invention the operating system is operative to enter a recovery mode if the file system whose label identifies it as the primary file system was mounted successfully and if the successfully mounted file system is not the primary file system.

In another aspect of the present invention the operating system is the Linux operating system.

In another aspect of the present invention the operating system is operative to swap the labels during bootstrapping when mounting /initrd.

In another aspect of the present invention a method is provided for primary and recovery file system management, the method including providing a primary file system, a recovery file system, and labels therefor, configuring, prior to bootstrapping by an operating system, the label of the recovery file system to identify the recovery file system as the primary file system, swapping the labels of the primary file system and the recovery file system during bootstrapping, attempting to mount the either of the file systems whose label identifies the file system as the primary file system, and swapping the labels of the primary and recovery file systems if the file system whose label identifies it as the primary file system was mounted successfully and if the successfully mounted file system is the primary file system.

In another aspect of the present the method invention further includes determining whether the mounted file system is either of the primary file system and the recovery file system.

In another aspect of the present invention the method further includes determining whether the mounted file system is either of the primary file system and the recovery file system by checking for the presence of a file on the primary file system that is known not to exist on the recovery file system.

In another aspect of the present invention the method further includes determining whether the mounted file system is either of the primary file system and the recovery file system when a third file system is mounted.

In another aspect of the present invention the method further includes determining where the third file system is the /temp file system under the Linux operating system.

In another aspect of the present invention the method further includes entering a recovery mode if the file system whose label identifies it as the primary file system was mounted successfully and if the successfully mounted file system is not the primary file system.

In another aspect of the present invention the steps are performed by the Linux operating system.

In another aspect of the present invention the method further includes swapping the labels during bootstrapping when mounting /initrd.

In another aspect of the present invention a computer program is provided embodied on a computer-readable medium, the computer program including a first code segment operative to configure, prior to bootstrapping by an operating system, the label of a recovery file system to identify the recovery file system as a primary file system, a second code segment operative to swap the labels of a primary file system and the recovery file system during bootstrapping, a third code segment operative to attempt to mount the either of the file systems whose label identifies the file system as the primary file system, and a fourth code segment operative to swap the labels of the primary and recovery file systems if the file system whose label identifies it as the primary file system was mounted successfully and if the successfully mounted file system is the primary file system.

### BRIEF DESCRIPTION OF THE DRAWINGS

The present invention will be understood and appreciated more fully from the following detailed description taken in conjunction with the appended drawings in which:

FIG. 1 is a simplified conceptual diagram of an operating system supporting primary and recovery file system management;.

FIG. 2 is a simplified flowchart illustration of an exemplary method of operation of the system of FIG. 1, useful in understanding the present invention; and

FIG. 3 is a simplified flowchart illustration of an exemplary method of operation of the system of FIG. 1, operative in accordance with a preferred embodiment of the present invention.

### DETAILED DESCRIPTION OF PREFERRED EMBODIMENTS

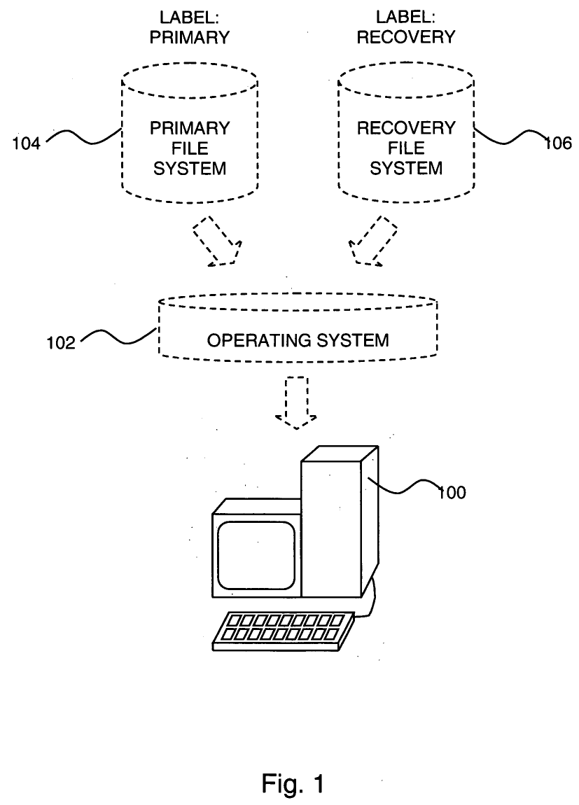

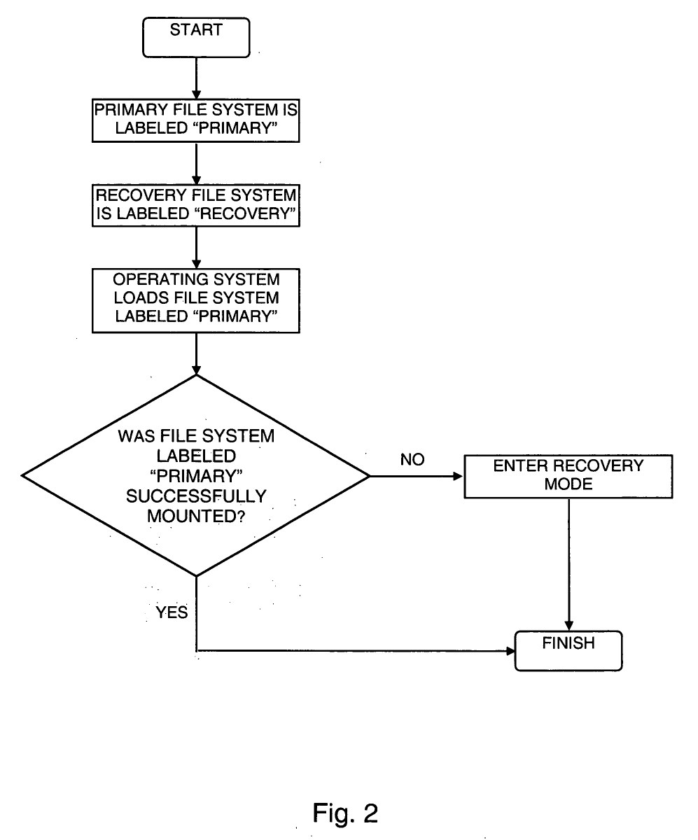

Reference is now made to FIG. 1, which is a simplified conceptual diagram of an operating system supporting primary and recovery file system management, and additionally to FIG. 2, which is a simplified flowchart illustration of an exemplary method of operation of the system of FIG. 1, useful in understanding the present invention. In the system and method of FIGS. 1 and 2, a computing device 100 includes an operating system 102, such as the Linux operating system, as well as a primary file system 104 and a recovery file system 106. Primary file system 104 and recovery file system 106 are both preferably uniquely labeled using conventional techniques. Thus, for example, in the Linux operating system the superblock of primary file system 104 may be labeled “Primary” while the superblock of recovery file system 106 may be labeled “Recovery.” During bootstrapping, operating system 102 identifies the label of the file system to be mounted, such as the label “Primary.” In the Linux operating system the label of the file system to be mounted may be specified by /initrd. Operating system 102 then attempts to mount primary file system 104. If primary file system 104 is not successfully mounted, operating system 102 may prompt a user, such as via a terminal attached to computing device 100, to specify an alternate file system for mounting, such as recovery file system 106. Unless operating system 102 is reconfigured to mount an alternate file system it will again attempt to mount primary file system 104.

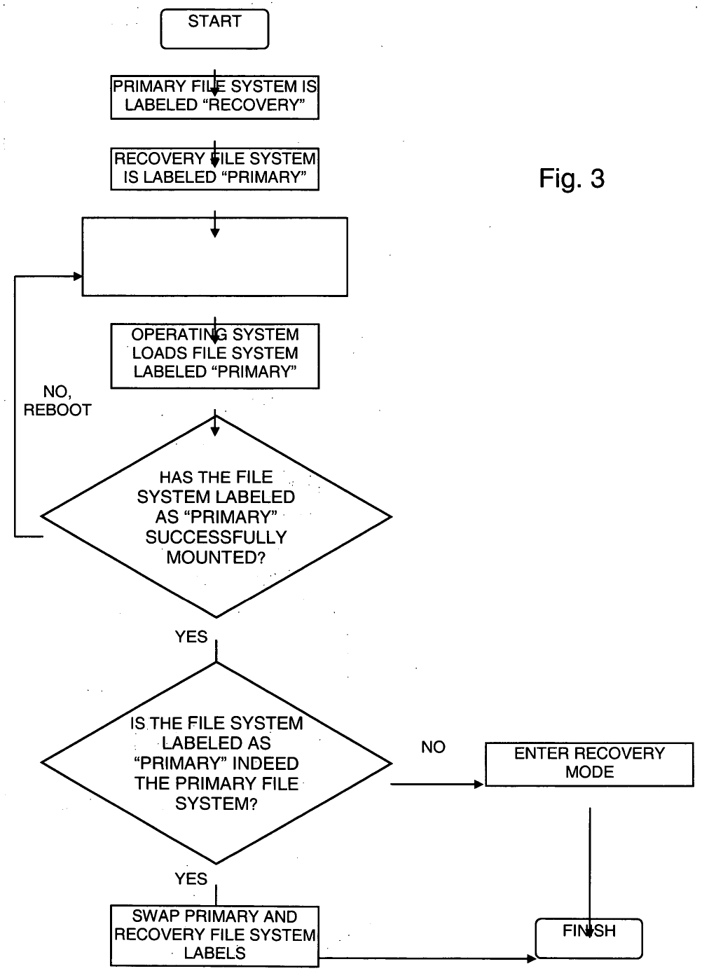

Reference is now made to FIG. 3, which is a simplified flowchart illustration of an exemplary method of operation of the system of FIG. 1, operative in accordance with a preferred embodiment of the present invention. In the method of FIG. 3, prior to bootstrapping operating system 102, the labels of primary file system 104 and recovery file system 106 are swapped, such that, for example, in the Linux operating system the superblock of primary file system 104 is labeled “Recovery” while the superblock of recovery file system 106 may be labeled “Primary.” During bootstrapping, operating system 102 preferably swaps the labels of primary file system 104 and recovery file system 106, such that, for example, in the Linux operating system the superblock of primary file system 104 is labeled “Primary” while the superblock of recovery file system 106 is labeled “Recovery.” In the Linux operating system this is preferably performed when mounting /initrd. Operating system 102 then identifies the label of the file system to be mounted, such as the label “Primary” as may be specified by /initrd in the Linux operating system. Operating system 102 then attempts to mount primary file system 104.

If the file system that is labeled, as the “Primary” file system mounted successfully, a check is performed to determine whether the mounted file system is indeed primary file system 104, or whether the mounted file system is recovery file system 106. This may be performed, for example, by checking for the presence of a file on primary file system 104 that is known not to exist on recovery file system 106. In the Linux operating system this is preferably performed when another file system, such as the /temp file system, is mounted. When this third file system is mounted, its mounting process checks whether or not the file system that is labeled as the primary file system mounted successfully, and, if so, whether the file system is indeed primary file system 104 or is just labeled as such. If the file system that is labeled as the “Primary” file system is verified to be primary file system 104, operating system 102 preferably swaps the labels of primary file system 104 and recovery file system 106, such that, for example, in the Linux operating system the superblock of primary file system 104 is labeled “Recovery” while the superblock of recovery file system 106 is labeled “Primary.”

If the file system that is labeled as the “Primary” file system did not mount successfully, then the labels of primary file system 104 and recovery file system 106 are left as is, and the system may be rebooted. When operating system 102 is next initialized, the labels of primary file system 104 and recovery file system 106 will be swapped, such that, for example, in the Linux operating system the superblock of primary file system 104 will be labeled “Recovery” while the superblock of recovery file system 106 will be labeled “Primary.” Operating system 102 then identifies the label of the file system to be mounted, such as the label “Primary” as specified by /initrd in the Linux operating system. Operating system 102 then attempts to mount recovery file system 106 which is now labeled as “Primary.”

If the file system that is labeled as the “Primary” file system mounted successfully and is verified to be recovery file system 106, computing device 100 may enter a service or recovery mode, may make an error log entry, and/or may take another preprogrammed action in response to the unsuccessful mounting of primary file system 104.

It may thus be seen that the present invention provides for the mounting of a recovery file: system after the unsuccessful mounting of a primary file system followed by a system reboot. The present invention does not require that the operating system be reconfigured after the unsuccessful mounting of a primary file system to mount a recovery file system, for if the system is rebooted the operating system will automatically attempt to mount a recovery file system.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A computer system having primary and recovery file system management, the system comprising:
a computing device;
an operating system;
a primary file system; and
a recovery file system, wherein:
each of said file systems is labeled,
prior to bootstrapping by said operating system the label of said recovery file system identifies said recovery file system as said primary file system, and
said operating system is operative to:
swap the labels of said primary and recovery file systems during bootstrapping,
attempt to mount said either of said file systems whose label identifies said file system as said primary file system, and
swap the labels of said primary and recovery file systems if the file system whose label identifies it as said primary file system was mounted successfully and if said successfully mounted file system is said primary file system.

2. A system according to claim 1 wherein said operating system is operative to determine whether said mounted file system is either of said primary file system and said recovery file system.

3. A system according to claim 1 wherein said operating system is operative to determine whether said mounted file system is either of said primary file system and said recovery file system by checking for the presence of a file on said primary file system that is known not to exist on said recovery file system.

4. A system according to claim 1 wherein said operating system is operative to determine whether said mounted file system is either of said primary file system and said recovery file system when a third file system is mounted.

5. A system according to claim 1 wherein said third file system is the /temp file system under the Linux operating system.

6. A system according to claim 1 wherein said operating system is operative to enter a recovery mode if the file system whose label identifies it as said primary file system was mounted successfully and if said successfully mounted file system is not said primary file system.

7. A system according to claim 1 wherein said operating system is the Linux operating system.

8. A system according to claim 7 wherein said operating system is operative to swap said labels during bootstrapping when mounting /initrd.

9. A method for primary and recovery file system management, the method comprising:
providing a primary file system, a recovery file system, and labels therefor;
configuring, prior to bootstrapping by an operating system, the label of said recovery file system to identify said recovery file system as said primary file system;
swapping the labels of said primary file system and said recovery file system during bootstrapping;
attempting to mount said either of said file systems whose label identifies said file system as said primary file system; and
swapping the labels of said primary and recovery file systems if the file system whose label identifies it as said primary file system was mounted successfully and if said successfully mounted file system is said primary file system.

10. A method according to claim 9 and further comprising determining whether said mounted file system is either of said primary file system and said recovery file system.

11. A method according to claim 9 and further comprising determining whether said mounted file system is either of said primary file system and said recovery file system by checking for the presence of a file on said primary file system that is known not to exist on said recovery file system.

12. A method according to claim 9 and further comprising determining whether said mounted file system is either of said primary file system and said recovery file system when a third file system is mounted.

13. A method according to claim 9 and further comprising determining where said third file system is the /temp file system under the Linux operating system.

14. A method according to claim 9 and further comprising entering a recovery mode if the file system whose label identifies it as said primary file system was mounted successfully and if said successfully mounted file system is not said primary file system.

15. A method according to claim 9 wherein said steps are performed by the Linux operating system.

16. A method according to claim 15 and further comprising swapping said labels during bootstrapping when mounting /initrd.

17. A computer program embodied on a computer-readable medium, the computer program comprising:
a first code segment operative to configure, prior to bootstrapping by an operating system, the label of a recovery file system to identify said recovery file system as a primary file system;
a second code segment operative to swap the labels of a primary file system and said recovery file system during bootstrapping;
a third code segment operative to attempt to mount said either of said file systems whose label identifies said file system as said primary file system; and
a fourth code segment operative to swap the labels of said primary and recovery file systems if the file system whose label identifies it as said primary file system was mounted successfully and if said successfully mounted file system is said primary file system.
